(19) United States
(12) Patent Application Publication
(10) Pub. No.: US 2016/0129427 A1
(43) Pub. Date: May 12, 2016

(54) Catalyst Composition for Photocatalytic Reduction of Carbon Dioxide

(71) Applicants: HINDUSTAN PETROLEUM CORPORATION LIMITED, Churchgate, Mumbai (IN); INDIAN INSTITUTE OF TECHNOLOGY, MADRAS, Madras, Chennai (IN)

(72) Inventors: Jeyalakshmi Velu, Chennai (IN); Krishnamurthy Ramaswamy Konda, Chennai (IN); Viswanathan Balasubramanian, Chennai (IN); Kanaparthi Ramesh, Bangalore (IN); Venkata Chalapathi Rao Peddy, Bangalore (IN); Venkateswarlu Choudary Nettem, Bangalore (IN); Sri Ganesh Gandham, Bangalore (IN)

(73) Assignees: Hindustan Petroleum Corporation Ltd., Mumbai (IN); Indian Institute of Technology, Madras, Chennai (IN)

(21) Appl. No.: 14/899,233

(22) PCT Filed: Aug. 27, 2013
(86) PCT No.: PCT/IN2013/000521

§ 371 Date: Dec. 17, 2015

(30) Foreign Application Priority Data
Jun. 17, 2013 (IN) 2039/MUM/2013

(51) Int. Cl. B01J 23/89; B01J 23/68; B01J 37/34; B01J 37/08; B01J 37/02; B01J 35/00; B01J 23/847; B01J 23/648

(52) U.S. Cl. CPC B01J 23/898; B01J 23/8476; B01J 23/682; B01J 23/6486; B01J 37/08; B01J 37/0201; B01J 37/0236; B01J 35/004; B01J 37/345; B01J 37/344

(57) ABSTRACT

The present subject matter describes a catalyst composition based on sodium tantalate, a modifying agent and at least one co-catalyst and the process of preparing the catalyst composition. The process for photocatalytic reduction of CO₂ comprises re-acting carbon dioxide and alkaline water in the presence of catalyst composition that is irradiated with radiation with wavelength in the range of 300-700 nm to produce lower hydrocarbons and hydrocarbon oxygenates.

### TECHNICAL FIELD

The subject matter described herein in general relates to a catalyst composition for photocatalytic reduction of carbon dioxide and the process for preparing the catalyst composition. In particular, the present disclosure relates to a catalyst composition comprising of sodium tantalate, a modifying agent, and at least one co-catalyst for producing lower hydrocarbons and hydrocarbon oxygenates by the photocatalytic reduction of carbon dioxide in the presence of water.

### BACKGROUND

The traditional fossil fuels, i.e., crude oil, gas and coal continue to be the major sources of energy in spite of the global efforts for alternative and renewable resources. Carbon dioxide (CO₂) is one of the gases emitted when fossil fuels are burned. CO₂ traps heat in the earth atmosphere but is not as potent a green house gas (GHG) as oxides of nitrogen, methane, and fluorinated gases. However, continued usage of fossil fuels has resulted in a drastic increase in atmospheric CO₂ levels over the past few decades. This is a matter of great concern since increasing levels of CO₂ emissions are related to global warming. Hence mitigation of CO₂ is the key challenge to contain global warming.

Efforts are being made worldwide to develop effective technologies to capture and utilize abundant CO₂. Conversion or recycling of CO₂ into high-energy content or value added fuels/chemicals, also known as chemical carbon mitigation, is an attractive avenue that is currently receiving world-wide attention. A wide range of CO₂ conversion techniques are under investigation, which include, chemical, photo-chemical, bio-chemical, bio-photochemical, radio-chemical, electro-chemical, electro-photochemical, bio-photo-electrochemical routes (Scibioh et al., Proc. Indn. Natl. Acad. Sci., 2004, 70 A(3), 407).

Conventional catalytic reduction of CO₂ to chemicals such as formic acid, methanol, methane etc. with external hydrogen source is feasible (Nam et al., Appl. Catalysis A. Gen., 1999, 179, 155). However, conventional routes for catalytic reduction of CO₂ are expensive. In order to make CO₂ reduction economical and sustainable, production of hydrogen has to be through sustainable routes.

Mitsui Chemicals, Japan, developed a process for methanol synthesis using a highly active catalyst formulation, CO₂ (released from a petrochemical plant), and hydrogen obtained by photo catalytic splitting of water (http://www.mitsui.chem.co.jp.e.dt, accessed August 2008). However, large scale production of hydrogen by photo catalytic or photo electro catalytic (PEC) routes is at its infancy.

Titania, modified titania catalysts, layered titania catalysts and many other mixed oxide catalysts have been used for photo catalytic reduction of CO₂ (Mori et al., RSC Advances, 2012, 2, 3165). JP 54.112813A discloses a process for photochemical reduction of CO₂ to formic acid using perylene or triphenyl amine as a donor and an aromatic hydrocarbon having electron withdrawing group like benzoquinone as an acceptor. NiO loaded NaTaO₃ doped with lanthanum has been used as a photocatalyst for water splitting into hydrogen and oxygen in stoichiometric amount under UV irradiation (Kudo et al., J. Am. Chem. Soc., 2003, 125, 3082).

Alkali metal tantalates have been used as photocatalyst for reduction of carbon dioxide in the presence of hydrogen to give carbon monoxide as the product. The photocatalytic activity of potassium tantalate was highest among all the alkali metal tantalates (Tanaka et al., Applied Catalysis B: Environmental, 2010, 96, 565). The dynamics of electrons photoexcited in NaTaO₃ based catalysts was studied by time resolved-IR absorption spectroscopy. Electrons excited in the La-doped NaTaO₃ were transferred to the co-catalyst (NiO) that mediated efficient electron transfer to water (Yamakata et al., J. Phys. Chem. B, 2003, 107, 14383).

CO₂ is a highly stable molecule and therefore its activation and conversion are highly energy intensive processes. A combination of activation procedures, catalytic/bio process, aided by photo and/or electro chemical activation is needed to achieve the desired conversion. Equally difficult is the reduction/splitting of water to yield hydrogen and hence requires similar combination of activation steps.

### SUMMARY

The subject matter described herein is directed towards a catalyst composition comprising: sodium tantalate (NaTaO₃) as a base catalyst; a modifying agent in the range of 0.5 to 5% w/w of the base catalyst; and at least one co-catalyst in an amount in the range of 0.05 to 5% w/w of the base catalyst.

Another aspect of the present disclosure provides a process for producing a catalyst, the process comprising: heating a mixture of tantalum pentoxide (Ta₂O₅), lanthanum trioxide, and NaOH in aqueous medium under hydrothermal conditions at a temperature range of 120-200° C. for a period of 4 to 24 h to obtain La₂O₃/NaTaO₃; and impregnating La₂O₃/NaTaO₃ with at least one salt of co-catalyst to obtain a catalyst composition.

Yet another aspect of the present disclosure provides a process for producing lower hydrocarbons and hydrocarbon oxygenates, the process comprising: suspending a catalyst composition in a solution of NaOH in water with stirring in a reactor to obtain a first mixture; passing carbon dioxide through the first mixture to obtain a second mixture with pH in the range of 8-12; and exposing the second mixture to electromagnetic radiation with wavelength in the range of 300-700 nm to produce lower hydrocarbons and hydrocarbon oxygenates.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 graphically illustrates a photo catalytic reactor for CO₂ reduction.

FIG. 2 graphically illustrates the X-ray diffractogram of NaTaO₃.

FIG. 3 graphically illustrates the effect of modifications in NaTaO₃ by addition of La₂O₃.

FIG. 4 graphically illustrates the morphology of NaTaO₃ prepared by hydrothermal route.

FIG. 5 graphically illustrates the electronic spectra of catalyst composites.

FIG. 6 graphically illustrates time on stream data for NiO—La:NaTaO₃.

FIG. 7 graphically illustrates the time on stream data for Pt—NiO—La:NaTaO₃.

FIG. 8 graphically illustrates the facile charge separation and transfer in NiO—La:NaTaO₃.

It should be appreciated by those skilled in the art that any block diagrams herein represent conceptual views of illustrative systems embodying the principles of the present subject matter.

### DETAILED DESCRIPTION

The present invention now will be described more fully hereinafter. Indeed, the invention may be embodied in many different forms and should not be construed as limited to the embodiments set forth herein: rather, these embodiments are provided so that this disclosure will satisfy applicable legal requirements. As used in the specification, and in the appended claims, the singular forms “a”, “an”, “the”, include plural referents unless the context clearly dictates otherwise.

The subject matter disclosed herein relates to a catalyst composition for photocatalytic reduction of carbon dioxide. It is the main object of the present disclosure to provide a catalyst composition comprising: sodium tantalate (NaTaO₃) as a base catalyst; a modifying agent; and at leastone co-catalyst. The metal in the catalyst composition may be present in their elemental form or as metal oxide or as metal salt or mixtures thereof.

An embodiment of the present disclosure relates to a catalyst composition comprising: sodium tantalate (NaTaO₃) as a base catalyst; a modifying agent in the range of 0.5 to 5% w/w of the base catalyst; and at least one co-catalyst in an amount in the range of 0.05 to 5% w/w of the base catalyst.

Another embodiment of the present disclosure provides a catalyst composition, wherein the modifying agent is selected from the group comprising of lanthanum trioxide (La₂O₃), La (Lanthanum), and mixtures thereof. Another embodiment of the present disclosure provides a catalyst composition, wherein the modifying agent is lanthanum trioxide (La₂O₃).

Yet another embodiment of the present disclosure provides a catalyst composition, wherein the modifying agent is impregnated on to NaTaO₃ to form La₂O₃/NaTaO₃. The modifying agent (La₂O₃) is anchored or deposited or impregnated on to the base catalyst (NaTaO₃) by hydrothermal process. Another way of representing La₂O₃/NaTaO₃ is La:NaTaO₃.

The present disclosure relates to a catalyst composition, comprising: sodium tantalate (NaTaO₃) as a base catalyst; a modifying agent in the range of 1 to 3% w/w of the base catalyst; and at least one co-catalyst in an amount in the range of 0.05 to 2% w/w of the base catalyst.

The present disclosure further relates to a catalyst composition, wherein the co-catalyst is impregnated on to La₂O₃/NaTaO₃. The co-catalyst is anchored or deposited or impregnated on to La₂O₃/NaTaO₃. In another embodiment of the present disclosure provides a catalyst composition, wherein the co-catalyst is selected from the group comprising of Pt, Ag, Au, RuO₂, CuO, NiO, and mixtures thereof. In yet another embodiment of the present disclosure provides a catalyst composition, wherein the co-catalyst is selected from the group comprising of Pt, Ag, Au, Ru, Cu, Ni, and mixtures thereof. The co-catalyst in the catalyst composition may be present in their elemental form or as metal oxide or mixtures thereof. The wt % of the co-catalyst is with respect to the base catalyst and is based on the elemental form of the co-catalyst. The present disclosure also provides a catalyst composition, wherein the catalyst composition is selected from the group comprising of Au/La₂O₃/NaTaO₃, Ag/La₂O₃/NaTaO₃, RuO₂/La₂O₃/NaTaO₃, Pt/La₂O₃/NaTaO₃, CuO/La₂O₃/NaTaO₃, NiO/La₂O₃/NaTaO₃, Pt/Ni/La₂O₃/NaTaO₃, and Pt/Cu/La₂O₃/NaTaO₃.

Another embodiment of the present disclosure provides a catalyst composition, wherein the catalyst composition is Au (0.05-2% w/w with respect to the base catalyst)/La₂O₃/NaTaO₃. In yet another embodiment of the present disclosure, provides a catalyst composition, wherein the catalyst composition is 1% w/w Au (with respect to the base catalyst)/La₂O₃/NaTaO₃.

The present disclosure further provides a catalyst composition, wherein the catalyst composition is Ag (0.05-2% w/w with respect to the base catalyst)/La₂O₃/NaTaO₃. In further embodiment of the present disclosure provides a catalyst composition, wherein the catalyst composition is 1% w/w Ag (with respect to the base catalyst)/La₂O₃/NaTaO₃.

Another embodiment of the present disclosure provides a catalyst composition, wherein the catalyst composition is RuO₂ (0.05-2% w/w with respect to the base catalyst)/La₂O₃/NaTaO₃. The present disclosure further provides a catalyst composition, wherein the catalyst composition is 1% w/w RuO₂ (with respect to the base catalyst)/La₂O₃/NaTaO₃.

Yet another embodiment of the present disclosure provides a catalyst composition, wherein the catalyst composition is Pt (0.05-2% w/w with respect to the base catalyst)/La₂O₃/NaTaO₃. The present disclosure provides a catalyst composition, wherein the catalyst composition is 0.15% w/w Pt (with respect to the base catalyst)/La₂O₃/NaTaO₃.

The present disclosure provides a catalyst composition, wherein the catalyst composition is CuO (1-3% w/w with respect to the base catalyst)/La₂O₃/NaTaO₃. In further embodiment of the present disclosure provides a catalyst composition, wherein the catalyst composition is 1% w/w CuO (with respect to the base catalyst)/La₂O₃/NaTaO₃.

Another embodiment of the present disclosure provides a catalyst composition, wherein the catalyst composition is NiO (0.1-0.5% w/w with respect to the base catalyst)/La₂O₃/NaTaO₃. The present disclosure further provides a catalyst composition, wherein the catalyst composition is 0.2% w/w NiO (with respect to the base catalyst)/La₂O₃/NaTaO₃.

Another embodiment of the present disclosure provides a catalyst composition, wherein the catalyst composition is Pt (0.05-2% w/w with respect to the base catalyst)/ Ni (0.05-2% w/w with respect to the base catalyst)/La₂O₃/NaTaO₃. In yet another embodiment of the present disclosure provides a catalyst composition, wherein the catalyst composition is 0.15% w/w Pt (with respect to the base catalyst)/ 0.2% w/w Ni (with respect to the base catalyst)/La₂O₃/NaTaO₃.

Another embodiment of the present disclosure provides a catalyst composition, wherein the catalyst composition is Pt (0.05-2% w/w with respect to the base catalyst)/ Cu (0.05-2% w/w with respect to the base catalyst)/La₂O₃/NaTaO₃. The present disclosure provides a catalyst composition, wherein the catalyst composition is 0.15% w/w Pt (with respect to the base catalyst)/1.0% w/w Cu (with respect to the base catalyst)/La₂O₃/NaTaO₃.

In yet another embodiment of the present disclosure provides a catalyst composition, wherein the catalyst composition is selected from the group comprising of 0.05-1.0% w/w of Pt with respect to the base catalyst 0.05-2.0% w/w of Ni with respect to the base catalyst, and La₂O₃/NaTaO₃; and 0.05-1.0% w/w of Pt with respect to the base catalyst, 0.05-2.0% w/w of Cu with respect to the base catalyst, and La₂O₃/NaTaO₃.

The subject matter described herein relates to photocatalytic reduction of carbon dioxide in presence of alkaline water to produce lower hydrocarbons and hydrocarbon oxygenates. The present disclosure relates to a catalyst composition wherein the catalyst composition is used for photo catalytic reduction of carbon dioxide in presence of alkaline water to produce lower hydrocarbons and hydrocarbon oxygenates.

The present disclosure further relates to a process for producing a catalyst composition, the process comprising: heating a mixture of tantalum pentoxide (Ta₂O₅), lanthanum trioxide, and NaOH in aqueous medium under hydrothermal conditions at a temperature range of 120-200° C. for a period of 4 to 24 h to obtain La₂O₃/NaTaO_{3:} and impregnating La₂O₃/NaTaO₃ with at least one salt of co-catalyst to obtain a catalyst composition.

An embodiment of the present disclosure relates to a process, wherein La₂O₃/NaTaO₃ is filtered and dried at 80-120° C. for 4-20 h before impregnation. Another embodiment of the present disclosure relates to a, process, wherein impregnation is followed by drying at 80-120° C. for 4-20 h.

In another embodiment of the present disclosure provides a process. wherein drying is optionally followed by reduction by inflow of hydrogen at a temperature range of 100-500° C. for a period of 5 to 10 h. The present disclosure relates to a process, wherein drying is optionally followed by calcination at a temperature range of 200-500° C. for a period of 2 to 24 h.

An embodiment of the present disclosure relates to a process, wherein the salt of the co-catalyst is selected from the group comprising of Ni(NO₃)₂.6H₂O, H₂PtCl₆, HAuCl₄, Ag(NO₃)₂, Cu(NO₃)₂.6H₂O), and RuCl₃.XH₂O.

The salts of copper of the present disclosure are selected from the group comprising of copper nitrate, copper chloride, and copper acetate. Salts of copper can be simply any organic or inorganic metal salts containing copper. An embodiment of the present disclosure relates to a process, wherein the salt of copper is Cu(NO₃)₂.6H₂O.

The present disclosure further relates to a process, wherein salts of platinum are selected from the group comprising of platinum acetate, platinum chloride, and platinum nitrate. Salts of platinum can be simply any organic or inorganic metal salts containing platinum. An embodiment of the present disclosure relates to a process, wherein the salt of platinum is H₂PtCl₆.

The salts of silver of the present disclosure are selected from the group comprising of silver nitrate, silver chloride, and silver acetate. Salts of silver can be simply any organic or inorganic metal salts containing silver. An embodiment of the present disclosure relates to a process, wherein the salt of silver is Ag(NO₃)₂.

An embodiment of the present disclosure relates to a process, wherein the salt of nickel is selected from the group comprising of nickel nitrate, nickel chloride, and nickel acetate. Salts of nickel can be simply any organic or inorganic metal salts containing nickel. An embodiment of the present disclosure relates to a process, wherein the salt of nickel is Ni(NO₃)₂.6H₂O.

The present disclosure further relates to a process, wherein salts of ruthenium are selected from the group comprising of ruthenium acetate, ruthenium chloride, and ruthenium nitrate. Salts of ruthenium can be simply any organic or inorganic metal salts containing ruthenium. An embodiment of the present disclosure relates to a process, wherein the salt of ruthenium is RuCl₃XH₂O.

The salts of gold of the present disclosure are selected from the group comprising of gold nitrate, gold chloride, and gold acetate. Salts of gold can be simply any organic or inorganic metal salts containing gold. An embodiment of the present disclosure relates to a process, wherein the salt of gold is HAuCl₄.

The present disclosure further relates to a process, wherein water is distilled and deionized. Any other purified form of water preferably non-ionic can also be used.

The present disclosure further relates to a process for producing lower hydrocarbons and hydrocarbon oxygenates, the process comprising: suspending a catalyst composition in a solution of NaOH in water with stirring in a reactor to obtain a first mixture; passing carbon dioxide through the first mixture to obtain a second mixture with pH in the range of 8-12; and exposing the second mixture to electromagnetic radiation with the wavelength in the range of 300-700 nm to produce lower hydrocarbons and hydrocarbon oxygenates.

The reactor used in the present disclosure is an all-glass thermostatic photo-catalytic reactor provided with a quartz window for irradiation of the catalyst suspension.

An embodiment of the present disclosure relates to a process, wherein carbon dioxide gas is pure and dried before use. Carbon dioxide is preferably purified by passing through hydrocarbon and moisture traps. The present disclosure describes a process, wherein the second mixture is exposed to radiation for 0.1 to 20 h at a temperature range of 20-40° C. The present disclosure further relates to a process, wherein the second mixture is exposed to radiation under ambient conditions.

In another embodiment of the present disclosure provides a process, wherein the lower hydrocarbon is selected from the group comprising of methane, ethane, and mixtures thereof. In another embodiment of the present disclosure, wherein hydrocarbon oxygenate is selected from the group comprising of methanol, ethanol, acetaldehyde, and mixtures thereof. The present disclosure relates to a process for photo catalytic transformation of carbon dioxide to a mixture of light hydrocarbons and hydrocarbon oxygenates which includes alcohols and aldehydes by reaction with water. The present disclosure further relates to a process for producing light hydrocarbons and hydrocarbon oxygenates including but not limited to methane, methanol, ethane, ethanol, acetone, formaldehyde, and free hydrogen.

Yet another embodiment of the present disclosure relates to a process, wherein the catalyst composition is used for photocatalytic reduction of carbon dioxide in presence of alkaline water to produce methanol selectively among other hydrocarbon oxygenates and lower hydrocarbons.

Another embodiment of the present disclosure relates to a process, wherein water is the hydrogen source for photo-catalytic reduction of carbon dioxide. The present disclosure also relates to a process wherein photons from visible light are used as source of energy and water as hydrogen (H₂) source for photo catalytic transformation of carbon dioxide to a mixture of light hydrocarbons and hydrocarbon oxygenates.

The present disclosure relates to a process, wherein the catalyst composition is dispersed in slurry state in aqueous alkaline solution, within a jacketed all glass reactor provided with a quartz window for irradiation of the dispersed medium. The present disclosure further relates to a process, wherein the catalyst composition is dispersed in alkaline solution and saturated with CO₂ before irradiating with visible light to facilitate the photo reduction of dissolved CO₂. The present disclosure relates to a process, wherein the alkaline solution increases the solubility of carbon dioxide. Yet another embodiment of the present disclosure relates to a process, wherein higher carbon dioxide concentration leads to higher yields of lower hydrocarbon and hydrocarbon oxygenates.

Another embodiment of the present disclosure relates to a process, wherein the light source is 250 W Hg lamp covering both UV & VIS region of light with wavelength in the range of 300-700 nm.

An embodiment of the present disclosure relates to a process for producing light hydrocarbons and hydrocarbon oxygenates from carbon dioxide by photo catalytic reduction of carbon dioxide at ambient temperature and atmospheric pressure. Catalyst composites prepared and characterized for structural and photo physical properties exhibited significant and stable activity for photo reduction of CO₂ with water to yield a range of useful hydrocarbons and hydrocarbon oxygenates. Thus NaTaO₃ based catalysts hold promise as potentially effective candidates for CO₂ photo reduction. It is observed that CO₂ photo reduction activity is closely related to the activity for photo catalytic splitting of water. NiO—La:NaTaO₃ with highest activity for water splitting also displays maximum activity for CO₂ photo reduction. Though ATaO₃,A=Li,Na &K catalysts have been investigated for photo reduction of CO₂, the process is based on external supply of hydrogen gas and the reduction is restricted to CO only.

In the present disclosure, hydrogen is generated in-situ by photo catalytic splitting/oxidation of water and a range of hydrocarbons are formed. It is observed that NaTaO₃ based catalysts exhibit exceptionally stable activity with methanol and ethanol as the major products. Pt, Ag, Au and RuO₂ act as efficient traps for photo generated electrons thus helping in minimization of charge carriers recombination and extend light absorption edge of La:NaTaO₃ which results in improved CO₂ conversion. On the other hand oxides like NiO and CuO play the role of coupled semiconductors since their conduction band energy. levels are suitable for facile transfer of electrons from the conduction band of NaTaO₃ as envisaged in FIG. 8 leading to effective charge separation and increase in activity.

Although the subject matter has been described in considerable detail with reference to certain preferred embodiments thereof, other embodiments are possible. As such, the spirit and scope of the appended claims should not be limited to the description of the preferred embodiment contained therein. Typical applications of the catalyst composites that constitute part of the present invention are given below in the form of examples.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

### Example 1

### Photocatalytic Reaction

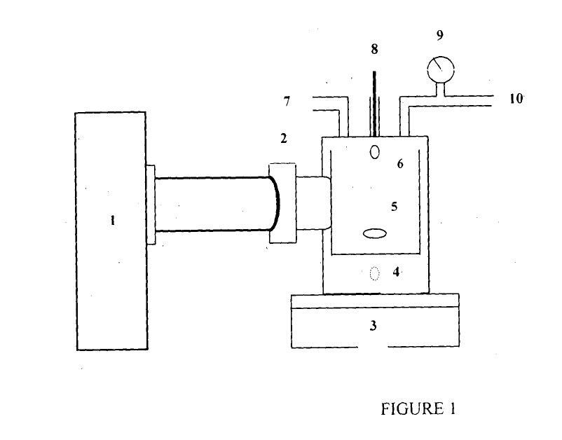

The CO₂ photo reduction process on NaTaO₃ based catalyst composites were conducted in slurry phase, in batch mode. An all-glass thermostatic photo-catalytic reactor (1) with a quartz window (2) (5 cm diameter) for light source as shown in FIG. 1 was used for studying the photo catalytic reduction of CO₂ by water. 250 W Hg lamp source (1) covering both UV & VIS region of light (300-700 nm) was used. 0.5 g of catalyst was dispersed in 500 ml of 0.2M aqueous NaOH solution to increase the solubility of CO₂ and act as a hole scavenger. Catalyst remained in a suspended state with continuous stirring with the help of a magnetic stirrer (3). Pure and dry CO₂ gas (purified by passing through hydrocarbon & moisture traps) was bubbled for 30 minutes to remove oxygen. When the aqueous alkaline solution was completely saturated with CO₂, pH of the medium was decreased from 13 to 8. Under these conditions, CO₂ available in the medium was estimated to be 70,000 μmoles. Reactor inlet (10) and outlet (7) were closed tightly with trapped CO₂ gas in contact with water. Photo chemical reaction in batch mode was initiated by switching on the irradiation. Gas and liquid samples were taken out at regular intervals & analyzed by GC. Reactions were carried out for 20 h. The temperature of the reaction medium was maintained at 25° C. by circulation of water (4,6) in the jacket. Amount of CO₂ consumed in the formation of all types of hydrocarbons and hydrocarbon oxygenates were observed in the GC analysis. Accordingly, conversion of CO₂ was calculated based on the stoichiometry.

### Example 2

### Control Experiment

No reaction could be observed without the catalyst and with catalyst in dark. When the aqueous alkaline medium with dispersed catalyst was purged, saturated with nitrogen and irradiated, very small quantities of hydrocarbons, possibly due to the conversion of residual carbon on catalyst surface, was observed up to six hours after which no product in measurable quantities could be detected. However, on purging and saturation with CO₂, hydrocarbons or hydrocarbon oxygenates in increasing amounts up to 20 h and beyond could be observed, thus establishing that the products are actually due to photo catalytic reduction of CO₂.

### Example 3

### Base Satalyst—NaTaO₃

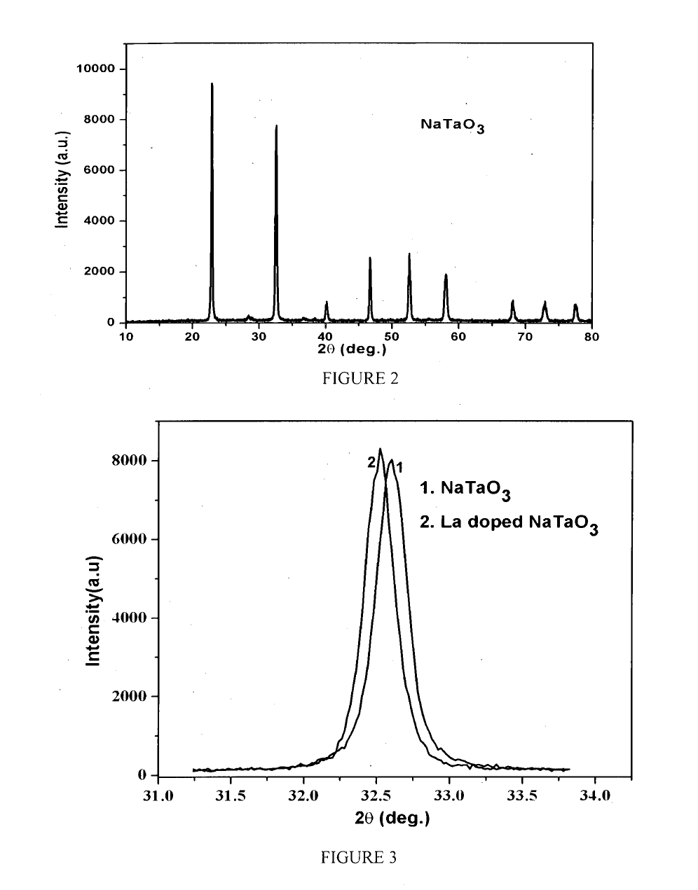

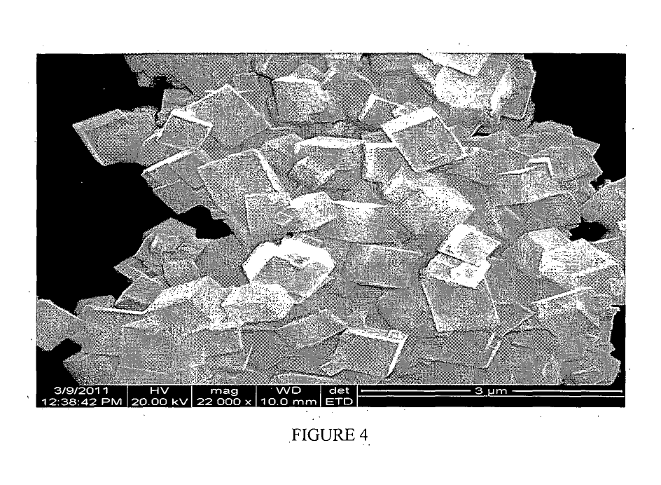

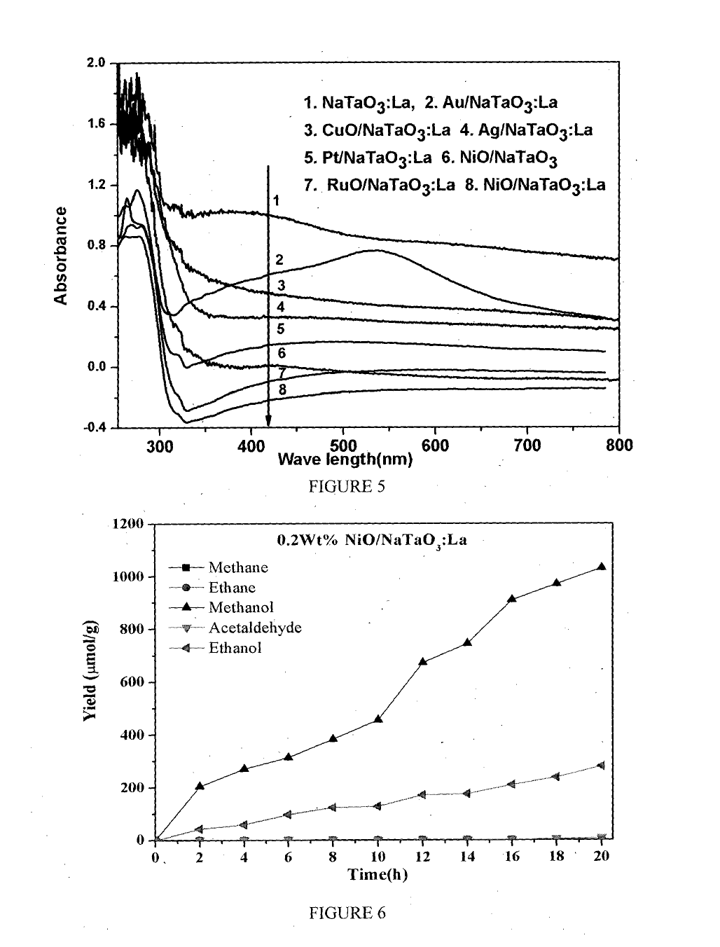

NaTaO₃ was prepared by adding 0.6 g of NaOH dissolved in 20 ml of water (0.75 M) and 0.442 g of Ta₂O₅ into a Teflon lined stainless steel autoclave. After hydrothermal treatment at 140° C. for 12 h, the precipitate was collected, washed with deionized water and ethanol and finally several times with water and dried at 80° C. for 5 h. (X.Li and J. Zang, J. Phys. Chem. C 2009, 113, 19411-19418) The base catalyst NaTaO₃ prepared by hydrothermal route showed. characteristic XRD pattern as indicated in FIG. 2. Cubic morphology displayed by the catalyst was revealed in FIG. 4 and typical electronic spectrum in FIG. 5, which gave band gap value of 3.88 eV. The CO₂ conversion realized along with product profile are given in Table 1. The base catalyst showed moderate activity for CO₂ photo reduction. The base catalyst was active for both reactions, i.e., splitting of water to yield hydrogen and reduction of CO₂ under irradiation.

TABLE 1
CO₂ photo reduction on NaTaO₃, La modified NaTaO₃ and with different co-
catalysts

| | Products formed after 20 hrs of irradiation (μmol/g) | | | | | | |
|---|---|---|---|---|---|---|---|
| | | | | | | Total CO₂ | Conversion |
| Catalyst | CH₄ | C₂H₆ | CH₃OH | CH₃CHO | C₂H₅OH | consumed | (%) |
| NaTaO₃ | 0.3 | 0.12 | 245.6 | 12.9 | 52.2 | 376.4 | 0.53 |
| NiO/NaTaO₃ | 0.4 | 0.15 | 334.9 | 2.5 | 48.9 | 438.5 | 0.62 |
| NaTaO₃:La | 1.3 | 0.11 | 544.9 | 0.5 | 47.5 | 642.4 | 0.9 |
| 1 Wt % Au/NaTaO₃:La | 0.5 | 0.2 | 604.4 | 1.5 | 57.7 | 723.8 | 1.01 |
| 1 Wt % Ag/NaTaO₃:La | 0.5 | 0.25 | 608.5 | 8 | 128.1 | 881.8 | 1.2 |
| 1 Wt % RuO₂/NaTaO₃:La | 0.4 | 0.2 | 536.2 | 1.1 | 197.9 | 935.1 | 1.3 |
| 0.15 Wt % Pt/NaTaO₃:La | 7.3 | 0.5 | 1007.7 | 3.1 | 21.3 | 1064.1 | 1.5 |
| 1 Wt % CuO/NaTaO₃:La | 0.16 | 0.28 | 940.1 | 7.1 | 270.5 | 1496.1 | 2.1 |
| 0.2 Wt % NiO/NaTaO₃:La | 0.4 | 0.2 | 1030.6 | 7.7 | 280.7 | 1608.2 | 2.3 |
| 0.15Pt/Ni/NaTaO₃:La | 3.4 | 3.7 | 1117.2 | 0.13 | 53.5 | 1235.2 | 1.7 |
| 0.15Pt/Cu/NaTaO₃:La | 0.53 | 1.8 | 1288.8 | 1.1 | 23.9 | 1343.1 | 1.9 |

### Example 4

NaTaO₃ Modified with Lanthana (La)

La modified NaTaO₃ was prepared by the same procedure as described above, by adding 0.0065 g of La₂O₃ along with NaOH and Ta₂O₅ in the autoclave. After hydrothermal treatment, the sample was washed and dried as described in Example 3. Addition of lanthana to the base catalyst results in structural changes as well as changes in photo physical properties (FIG. 5) of the La doped catalyst. The effect of La doping was revealed by shift in XRD d-lines (FIG. 3) and band gap values for La tantalate, (4.1 eV) vs 3.88 eV observed for pure NaTaO₃. These changes result in an increase in CO₂ conversion as indicated in Table 1. As compared to the base catalyst; addition of La on to NaTaO₃ resulted in an increase of CO₂ conversion and marked increase in the production of methane and methanol selectively among all the products.

### Example 5

NaTaO₃ with NiO as Co-Catalyst but Without Lanthana

NiO as a co-catalyst was impregnated on sodium tantalate without lanthana. Though there was marginal increase in the CO₂ photo conversion, the quantum of increase was less than that observed for La:NaTaO₃ as indicated in Table 1.

### Example 6

NaTaO₃ Modified with Lanthana Along with Co-Catalyst

NiO (0.2% w/w) as co-catalyst was loaded on to synthesized NaTaO₃:La powder by wet impregnation from an aqueous solution of Ni (NO₃)₂.6H₂O, drying at 100° C. followed by calcination in air at 270° C. for 2 h. Similarly, 0.15 w/w % Pt (as H₂PtCl₆) and 1.0 w/w % Au (as HAuCl₄) were loaded onto synthesized NaTaO₃:La powder by wet impregnation and dried. Pt & Au salts were reduced in hydrogen at 450° C. and 200° C. respectively prior to use. 1% wt each of Ag (as Ag(NO₃)₂), CuO (as, Cu(NO₃)₂.6H₂O) and RuO₂ (as RuCl₃XH₂O) were loaded on La:NaTaO₃ by wet impregnation and dried and calcined at 300° C.

### Example 7

NaTaO₃ Modified with Lanthana Along with NiO as Co-Catalyst

NiO as co-catalyst was added on La modified NaTaO₃. Presence of both La & NiO resulted in substantial increase in CO₂ photo reduction with 2.3% of CO₂ getting converted, as seen in Table 1 and FIG. 6. Highly effective synergy in the electronic energy levels of NaTaO₃ and NiO, as represented in FIG. 8, facilitated facile charge transfer which resulted in the high activity observed with NiO—La:NaTaO₃. The use of NiO as a co-catalyst in the catalyst composition surprisingly results in sharp increase in the production of methanol and ethanol selectively among all the products as compared to La:NaTaO₃: Importantly, no marked differences were observed for methane, ethane, and acetaldehyde.

### Example 8

NaTaO₃ Modified with Lanthana Along with CuO as Co-Catalyst

Addition of 1% wt CuO as co-catalyst to La:NaTaO₃ brought substantial reduction in the band gap from 4.09 to 3.4 eV as revealed in FIG. 5. Like NiO, CuO also facilitated charge transfer thus resulting in higher CO₂ conversion of 2.1%, (Table 1) compared to 2.3% realized with NiO as co-catalyst.

### Example 9

NaTaO₃ Modified with Lanthana with Pt/Au/Ag and RuO₂ as Co-Catalysts

Compared to La:NaTaO₃ use of Pt, Au, Ag & Rua, as co-catalysts improve the CO, conversion but are not as effective as NiO/CuO (Table 1). According to FIG. 5 these four co-catalysts reduce the band gap of La:NaTaO₃ thus extending light absorption in the visible region. Au also shows additional plasmon resonance absorption. These four co-catalysts act as electron traps, thus facilitating charge separation. The use of platinum as a co-catalyst in the catalyst composition results in marked increase in the formation of methane along with a decrease in the formation of ethanol. This is indeed unexpected as compared to the other co-catalyst like Au, Ag, or RuO₂.

### Example 10

NaTaO₃ Modified with Lanthana with Pt—Cu and Pt—Ni as Bimetallic Co-Catalysts

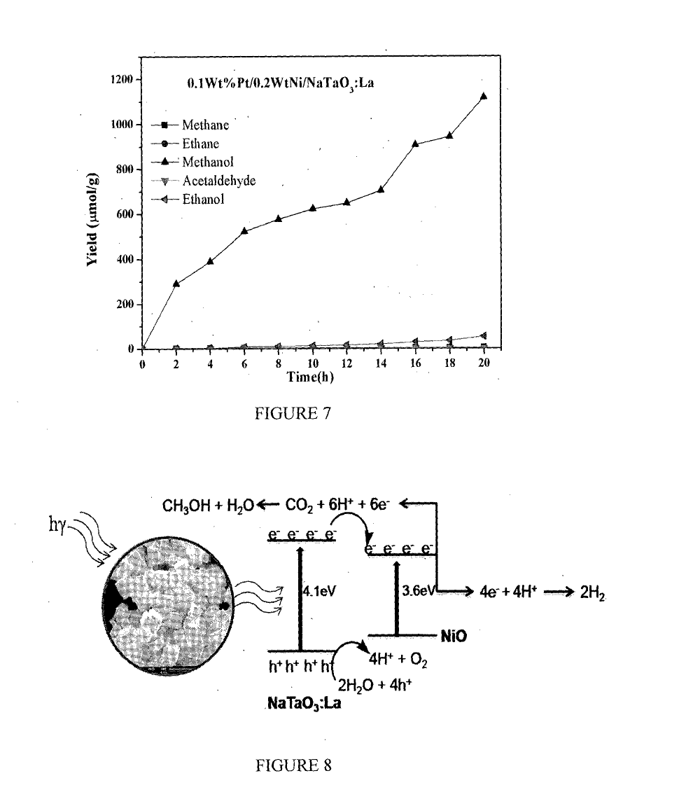

The product distribution for all the catalysts showed methanol and ethanol as major products, with methane, ethane and acetaldehyde as minor products. Formation of methane and ethane are relatively higher with Pt. Since maximum conversion is observed with NiO and CuO as co-catalyst, bi-metallic co-catalysts, Pt—Cu and Pt—Ni were used with La:NaTaO₃. Results presented in Table 1 and FIG. 7 indicate that there is a substantial increase in methane and/or ethane formation along with higher amount of methanol in comparison with corresponding mono metallic co-catalysts. This was unexpected results as compared to mono-metallic co-catalysts.

I/We claim:

1. A catalyst composition comprising:
(a) sodium tantalate (NaTaO₃) as a base catalyst;
(b) a modifying agent in the range of 0.5 to 5% wlw of the base catalyst; and
(c) at least one bimetallic co-catalyst in an amount in the range of 0.05 to 5% w/w of the base catalyst.

2. The catalyst composition as claimed in claim 1, wherein the modifying agent is selected from the group consisting of lanthanum trioxide (La₂O₃), La, and mixtures thereof.

3. The catalyst composition as claimed in claim 1, wherein the modifying agent is impregnated on to NaTaO₃ to form La₂O₃/NaTaO₃.

4. The catalyst composition as claimed in claim 1, wherein the bimetallic co-catalyst is selected from the group consisting of Pt, Ag, Au, RuO₂, CuO, NiO, and mixtures thereof.

5. The catalyst composition as claimed in claim 1, wherein the bimetallic co-catalyst is selected from the group consisting of Pt—Ni and Pt—Cu.

6. The catalyst composition as claimed in claim 1, wherein the bimetallic co-catalyst is impregnated on to La₂O₃/NaTaO₃.

7. The catalyst composition as claimed in claim 1, wherein the catalyst composition is selected from the group consisting of Au/La₂O₃/NaTaO₃, Ag/La₂O₃/NaTaO₃, RuO₂/La₂O₃/NaTaO₃, Pt/La₂O₃/NaTaO₃, CuO/La₂O₃/NaTaO₃, NiO/La₂O₃/NaTaO₃, Pt/Ni/La₂O₃/NaTaO₃, and Pt/Cu/La₂O₃NaTaO₃.

8. The catalyst composition as claimed in claim I, wherein the amount of bimetallic co-catalyst is in the range 0.05 to 2% w/w of the base catalyst.

9. The catalyst composition as claimed in claim 1, wherein the catalyst composition is selected from the group consisting of 0.05-1.0% w/w of Pt with respect to the base catalyst, 0.05-2.0% w/w of Ni with respect to the base catalyst, and La₂O₃/NaTaO₃; and 0.05-1.0% w/w of Pt with respect to the base catalyst, 0.05-2.0% w/w of Cu with respect to the base catalyst, and La₂O₃/NaTaO₃.

10. The catalyst composition as claimed in claim 1, wherein the catalyst composition is used for photo catalytic reduction of carbon dioxide in presence of alkaline water to produce lower hydrocarbons and hydrocarbon oxygenates.

11. A process for producing a catalyst composition as claimed in claim 1, the process comprising:
(a) heating a mixture of tantalum pentoxide (Ta₂O₅), lanthanum trioxide, and NaOH in aqueous medium under hydrothermal conditions at a temperature range of 120-200° C. for a period of 4 to 24 h to obtain La₂O₃/NaTaO₃; and
(b) impregnating La₂O₃₁NaTaO₃ with at least one salt of bimetallic co-catalyst to obtain a catalyst composition.

12. The process as claimed in claim 11, wherein La₂O₃/NaTaO₃ is filtered and dried at 80-120° C. for 4-20 h before impregnation.

13. The process as claimed in claim 11, wherein impregnation is followed by drying at 80-120° C. for 4-20 h.

14. The process as claimed in claim 13, wherein drying is optionally followed by calcination at a temperature range of 200-500° C. for a period of 2 to 24 h.

15. The process as claimed in claim 13, wherein drying is optionally followed by reduction by inflow of hydrogen at a temperature range of 100-500° C. for a period of 5 to 10 h.

16. The process as claimed in claim 11, wherein the salt of the bimetallic co-catalyst is selected from the group consisting of Ni (NO₃)₂.6H₂O, H₂PtCl₆, HAuCl₄, Ag(NO₃)₂, Cu(NO₃)₂.6H₂O), and RuCl₃XH₂O.

17. A process for producing lower hydrocarbons and hydrocarbon oxygenates, the process comprising:
(a) suspending a catalyst composition as claimed in claim 1 in a solution of NaOH in water with stirring in a reactor to obtain a first mixture;
(b) passing carbon dioxide through the first mixture to obtain a second mixture with pH in the range of 8-12; and
(c) exposing the second mixture to electromagnetic radiation with the wavelength in the range of 300-700 nm to produce lower hydrocarbons and hydrocarbon oxygenates.

18. The process as claimed in claim 17, wherein the reactor is an all-glass thermostatic photo-catalytic reactor provided with a quartz window for irradiation of the catalyst suspension.

19. The process as claimed in claim 17, wherein carbon dioxide gas is pure and dried before use.

20. The process as claimed in claim 17, wherein the second mixture is exposed to radiation for 0.1 to 20 h at a temperature range of 20-40° C.

21. The process as claimed in claim 17, wherein the lower hydrocarbon is selected from the group consisting of methane, ethane, and mixtures thereof.

22. The process as claimed in claim 17, wherein hydrocarbon oxygenate is selected from the group consisting of methanol, ethanol, acetaldehyde, and mixtures thereof.

23. The process as claimed in claim 17, wherein water is the hydrogen source for photo-catalytic reduction of carbon dioxide.

24. The process as claimed in claim 17, wherein the catalyst composition is used for photocatalytic reduction of carbon dioxide in presence of alkaline water to produce methanol selectively among other hydrocarbon oxygenates and lower hydrocarbons.
